(19) United States
(12) Patent Application Publication
(10) Pub. No.: US 2008/0257754 A1
(43) Pub. Date: Oct. 23, 2008

(54) METHOD AND APPARATUS FOR ENTRY OF SPECIMENS INTO A MICROFLUIDIC DEVICE

(76) Inventors: Michael J. Pugia, Granger, IN (US); James A. Profitt, Goshen, IN (US); Gert Blankenstein, Dortmund (DE); Ralf-Peter Peters, Bergisch Gladbach (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/102,631

(22) Filed: Apr. 14, 2008

Related U.S. Application Data
(63) Continuation-in-part of application No. 10/608,671, filed on Jun. 27, 2003, now abandoned.

(51) Int. Cl. G01N 27/26

(52) U.S. Cl. 205/792; 204/403.01

(57) ABSTRACT

A microfluidic device for analyzing biological samples is provided with a sample inlet section including an inlet port, a capillary passageway communication with the inlet port and with an inlet chamber. The inlet chamber includes means for uniformly distributing the sample liquid across the inlet chamber and purging the air initially contained therein.

This is a continuation in-part of U.S. Ser. No. 10/608,671, filed Jun. 27, 2003.

### BACKGROUND OF THE INVENTION

This invention relates to microfluidic devices, particularly those that are used for analysis of biological samples. Microfluidic devices are intended to be used for rapid analysis, thus avoiding the delay inherent in sending biological samples to a central laboratory. Such devices are intended to accept very small samples of blood, urine, and the like. The samples are brought into contact with reagents capable of indicating the presence and quantity of analytes found in the sample.

Many devices have been suggested for carrying out analysis near the patient, some of which will be discussed below. In general, such devices use only small samples, typically 0.1 to 200 μL. With the development of microfluidic devices the samples have become smaller, which is a desirable feature of their use. However, smaller samples introduce difficult problems. In microfluidic devices, small samples, typically about 0.1 to 20 μL, are brought into contact with one or more wells where the samples are prepared for later analysis or reacted to indicate the presence (or absence) of an analyte. As the sample is moved into a well, it is important that the liquid is uniformly distributed such that all the air in the well is expelled, since air will adversely affect the movement of liquid and the analytical results. Also, there are other problems associated with the initial introduction of the sample to the microfluidic device.

At first, the inlet port of such devices contains air, which must be expelled. A small amount of liquid must be deposited under conditions which force air out, but leave the sample in the inlet port and not on the surface of the device. Specimens on the surface will cause carry-over and contamination between analyses. Air in the port will cause under-filling and, consequently, under estimation of the analytical results. Air bubbles in the inlet port or the receiving inlet chamber might interfere with the further liquid handling, especially if lateral capillary flow is used for further flow propulsion. One solution is to seal the inlet port to a pipette containing the sample liquid so that a plunger in the pipette can apply pressure to the inlet port. The flow through a capillary extending from the inlet port to the first well must prevent air bubbles from forming in the capillary or in the entry to the first well. As the capillary enters the first well, the liquid should be distributed evenly as the passageway widens into the well. Here also, the movement of the liquid must be controlled that air is moved ahead of the liquid and expelled through a vent passage. The goal is to force all the air in the well to exit via the vent as it is replaced with the liquid sample. If the vent passage is blocked by liquid before all of the well air has escaped, air bubbles will form in the well and reduce the accuracy of the test.

While the sample may be directed immediately to a well containing reagents, it Often will be sent initially to a metering well used to define the amount of the sample which later will be sent to other wells for preparation of the sample for subsequent contact with reagents. It is important that the metering well be completely filled, that is, all the air has been replaced with liquid. If the well is under-filled due to the presence of air bubbles then the measurements are affected because less liquid is available for the analysis. If the well is over-filled, excess liquid will enter the downstream micro fluidic circuit and interfere with the processing of the correct sample volume. Consequently, an overflow well may be provided to accommodate liquid in excess of the sample to be assayed. Since precision in metering a sample requires that all the air originally in the well be expelled, the method used introduce a sample liquid into a well that defines the volume to be assayed should prevent trapping of air.

The present invention has been developed to overcome the problems discussed above and to assure that a microfluidic device including an improved inlet port of the invention provides accurate and repeatable results and allows containment and protection from under and over-filling.

In two patents and a pending application (U.S. Pat. No. 6,113,855; U.S. Pat. No. 6,669,907; US 2005/0147531 A1) Buechler disclosed a microfluidic assay device, shown in FIG. 1, where liquid flows from one region to another; the regions were designated proximal and distal regions. The distal region was defined as having capillary forces equal to or greater than in the proximal region. Since the distal region was required to have a larger volume than the proximal region, which would tend to give the distal region a lower capillary force, capillarity-inducing structures were used to provide greater capillary forces, thereby inducing flow into the distal region (as represented by the arrows in FIG. 1). A special feature of the Buechler assay device was that capillary forces in the proximal region were induced between surfaces in the vertical direction, while in the distal region capillary forces were induced between surfaces in the horizontal direction. As used by Buechler, vertical direction refers to the distance between the top and bottom inner surfaces of the device (i.e. the height), while horizontal direction refers to the distance between the lateral walls (i.e. the width). In the proximal region, the vertical distance is smaller than the distance between the lateral walls and induces the capillary forces in the vertical direction. Conversely, in the distal region the distance between the lateral walls is smaller than the vertical distance between the top and bottom surfaces, so that the horizontal distance between the lateral walls controls the capillary forces.

Buechler's objective was to cause liquid to flow from the proximal region into a larger distal region (as shown by the arrows in FIG. 1) by adding capillarity inducing structures that provided capillary forces in the distal region equal to or larger than those in the proximal region in order to draw the liquid downstream. The effect on removal of air from the distal region was not discussed by Buechler. The present inventors have found that Buechler's structure would cause liquid to flow too rapidly downstream causing air to be trapped in the distal region thereby forming air pockets (likely in the area indicated in FIG. 1). The effect would be that the distal region would not contain the desired amount of liquid, which is important if assay results are to be reliable. The inventors have found that, rather than providing equal or greater capillary forces on the distal region, as taught by Buechler, lower capillary forces should be used so that air can be expelled completely, as will be shown below.

### SUMMARY OF THE INVENTION

The invention relates in particular to entry ports adapted to supply small samples of 0.1 to 20 μL to microfluidic chips, thereby making possible accurate and repeatable assays of the analytes of interest in such samples. Such entry ports provide access for small samples and transfer of the samples uniformly into an inlet chamber while purging air from the microfluidic chip without trapping air bubbles in the chamber. Uniform distribution of the sample may be done by including grooves or weirs across the inlet chamber, which may contain wedge-shaped cutouts or other features to assist in distributing flow of the sample uniformly. Alternatively, microstructures, such as an array of posts, may be used to provide uniform distribution of the sample while completely purging air from the chamber. The requirements for grooves, weirs and microposts are described in examples below.

In some embodiments, the microfluidic chip will include an overflow chamber, preferably containing an indicator to assure complete filling of the inlet chamber. Such an overflow chamber receives excess liquid when the other exits from the inlet chamber include capillary stops that prevent movement of the excess liquid into a downstream microfluidic circuit.

In one aspect, the invention includes a method of supplying liquid to a microfluidic device in which liquid is introduced to an inlet port, from which it flows through a capillary passageway by capillary forces into an inlet chamber, where the liquid is distributed uniformly across the chamber while completely purging air from the chamber through a vent. Microstructures are disposed in the chamber so as to reduce the capillary forces that move the liquid relative to the capillary forces in the inlet capillary passageway. When an array of microposts is used, the spacing between the posts is equal to or greater than the height of the inlet chamber, thereby reducing the capillary forces. When grooves or weirs are disposed at a right angle to the flow of liquid in the inlet chamber, the groove or weir has a width greater than the height of the inlet chamber, thereby reducing capillary forces.

In another aspect, the invention includes a microfluidic device which has an inlet port for receiving a liquid sample and a capillary passageway connecting the inlet port with an inlet chamber. The inlet chamber contains microstructures that are disposed to reduce the capillary forces from those induced within the capillary passageway. When the microstructures are an array of posts, the spacing between the posts is greater than the height of the chamber. When the microstructures are grooves or weirs disposed at a right angle to the flow of liquid in the chamber, the groove or weir has a width greater than the height of the inlet chamber.

### BRIEF DESCRIPTION OF THE DRAWINGS

FIG. 1 illustrates a prior art device and its deficiencies.

FIG. 2 is a schematic of a new and improved microfluidic device according to the present invention.

FIG. 3a illustrates a portion of a microfluidic chip used in Example 3 for determination of glucose in 50 samples.

FIG. 3b is an enlarged portion of FIG. 3a.

FIG. 3c is an enlarged post from FIG. 3b.

FIG. 4 shows a cross-sectional view of the microfluidic chip of FIG. 3b.

FIG. 5 illustrates a group of inlet ports.

FIG. 6 shows a microfluidic disk for analysis of urine according to the present invention.

FIG. 7 shows a microfluidic chip for immuno analysis according to the present invention.

### DESCRIPTION OF THE PREFERRED EMBODIMENTS

### Basic Structure of the Device

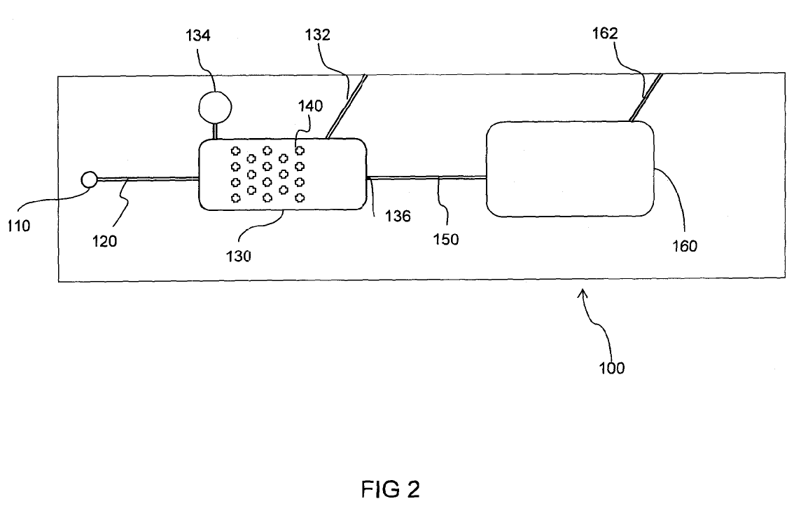

Referring now to FIG. 2, a simple embodiment of the microfluidic device 100 for assaying a liquid biological sample according to the present invention is shown. The microfluidic device 100 includes a port 110 for receiving sample, a first chamber 130, a first capillary passageway 120 in fluid communication with the port 110 and the chamber 130 for moving the sample by capillary forces from the port 110 to the chamber 130, and at least one vent passageway 132 off the chamber 130 to the atmosphere for removing air displaced by the liquid sample. The chamber 130 contains microstructures 140 disposed within the chamber 130 to reduce the capillary force exerted on the sample as it moves from the capillary passageway 120 into the chamber 130, thereby evenly and uniformly distributing the sample across the chamber 130 and displacing air from the chamber 130. The microfluidic device 100 may also include a second capillary 150 in fluid communication with the first chamber 130 and a second chamber 160. The second chamber also has at least one vent passageway 162 to the atmosphere to remove air displaced by the liquid sample. Fluid is prevented from leaving the first chamber 130 and flowing through the second capillary 150 by a capillary stop 136. The microfluidic device 100 may also have an overflow well 134 in fluid communication with the first chamber 130 via a capillary to prevent overfilling the chamber. The various components introduced herein and the mechanisms by which they function are described in greater detail below.

### Flow in Microchannels

The microfluidic devices of the invention typically use smaller channels than have been proposed by previous workers in the field. In particular, the channels used in the invention have widths in the range of about 10 to 500 μm, preferably about 20-100 μm, whereas channels an order of magnitude larger have typically been used by others when capillary forces are used to move fluids. The minimum dimension for such channels is believed to be about 5 μm, since smaller channels may effectively filter out components in the sample being analyzed. Channels in the range preferred in the invention make it possible to move liquid samples by capillary forces alone. It is also possible to stop movement by capillary walls that have been treated to become less hydrophilic (or hydrophobic) relative to the sample fluid. The resistance to movement can be overcome by a pressure difference, for example, by applying centrifugal force, pumping, vacuum, electroosmosis, heating, or additional capillary force. As a result, liquids can be metered and moved from one region of the device to another as required for the analysis being carried out.

A mathematical model has been derived which relates the capillary force, the fluid physical properties, the fluid surface tension, the surface energy of the capillary walls, the capillary size and the surface energy of particles contained in fluids to be analyzed. It is possible to predict the flow rate of a fluid through the capillary and the desired degree of hydrophobicity or hydrophilicity. The following general principles can be drawn from the relationship of these factors.

For any given passageway, the interaction of a liquid with the surface of the passageway may or may not have a significant effect on the movement of the liquid. When the surface to volume ratio of the passageway is large i.e. the cross-sectional area is small, the interactions between the liquid and the walls of the passageway become very significant. This is especially the case when one is concerned with passageways with nominal diameters less than about 200 μm, when capillary forces related to the surface energies of the liquid sample and the walls predominate. This is especially true when the surfaces have been coated to have low surface energy and are highly hydrophilic. When the walls are wetted by the liquid, the liquid moves through the passageway without external forces being applied. Conversely, when the walls are not wetted by the liquid, the liquid attempts to withdraw from the passageway. These general tendencies can be employed to cause a liquid to move through a passageway or to stop moving at the junction with another passageway having a different cross-sectional area. If the liquid is at rest, it can be moved by a pressure difference. Examples include air pressure, hydrostatic pressure, vacuum, electroosmosis, heat, centrifugal force and the like, which are able to induce the needed pressure change at the junction between passageways having different cross-sectional areas or surface energies. In the present invention, the passageways through which liquids move are smaller and are combined with lower surface energies than have been used heretofore. This results in higher capillary forces being available and makes it possible to move liquids by capillary forces alone, without requiring external forces, which are only needed for short periods when a capillary stop must be overcome. Since the smaller passageways inherently are more likely to be sensitive to obstruction from particles in the biological samples or the reagents, the surface energy of the passageway walls can be reduced as required for use with the sample fluid to be tested, e.g. blood, urine, and the like. This feature allows more flexible designs of analytical devices to be made. The devices can be smaller than the microfluidic formats that have been used in the art and can operate with smaller samples. However, using smaller samples introduces new problems that are overcome by the present invention. One such problem is associated with the introduction of small samples in such a way that the device is filled uniformly and air is purged. As the capillary forces are very strong, fluid moves with high velocity through the device and air can be trapped in the device leading to under-filling. Air also can block or interfere with all liquid handling steps further downstream related to the liquid transport, especially valving of liquids by capillary stops. Over-filling the device can lead to carry-over and the activation of downstream fluidic circuits prematurely. The ability to have proper filling and to detect whether improper filing occurs is required for accurate analysis.

### Microfluidic Analytical Devices

The analytical devices of the invention may be referred to as “chips”. They are generally small and flat, typically about 1 to 2 inches square (25 to 50 mm square) or disks having a radius of about 40 to 80 mm. The volume of samples will be small. For example, they will contain only about 0.1 to 10 μL for each assay, although the total volume of a specimen may range from 10 to 200 μL. The wells for the sample fluids will be relatively wide and shallow in order that the samples can be easily seen and changes resulting from reaction of the samples can be measured by suitable equipment. The interconnecting capillary passageways will have a width in the range of 10 to 500 μm, preferably 20 to 100 μm, and the shape will be determined by the method used to form the passageways. The depth of the passageways should be at least 5 μm.

While there are several ways in which the capillaries and sample can be formed, such as injection molding, laser ablation, diamond milling or embossing, it is preferred to use injection molding in order to reduce the cost of the chips. Generally, a base portion of the chip will be cut to create the desired network of sample wells and capillaries and then, after reagents have been placed in the wells as desired, a top portion will be attached over the base to complete the chip.

The chips are intended to be disposable after a single use. Consequently, they will be made of inexpensive materials to the extent possible, while being compatible with the reagents and the samples which are to be analyzed. In most instances, the chips will be made of plastics such as polycarbonate, polystyrene, polyacrylates, or polyurethane, alternatively, they can be made from silicates, glass, wax or metal.

The capillary passageways typically are hydrophilic, which is defined with respect to the contact angle formed at a solid surface by a liquid sample or reagent. Typically, a surface is considered hydrophilic if the contact angle is less than 90° and hydrophobic if the contact angle is greater than 90°. Preferably, plasma induced polymerization is carried out at the surface of the passageways. The analytical devices of the invention may also be made with other methods used to control the surface energy of the capillary walls, such as coating with hydrophilic or hydrophobic materials, grafting, or corona treatments. It is preferred that the surface energy of the capillary walls is adjusted, i.e. the degree of hydrophilicity or hydrophobicity, for use with the intended sample fluid. For example, to prevent deposits on the walls of a hydrophobic passageway or to assure that none of the liquid is left in a passageway. For most passageways in the present invention, the surface is generally hydrophilic since the liquid tends to wet the surface and the surface tension forces causes the liquid to flow in the passageway. For example, the surface energy of capillary passageways can be adjusted by known methods so that the contact angle of water is between 10° to 60° when the passageway is to contact whole blood or a contact angle of 25° to 80° when the passageway is to contact urine.

Movement of liquids through the capillaries may be prevented by capillary stops, which, as the name suggests, stop liquids from flowing through the capillary by a change in capillary forces. If the capillary passageway promotes liquid flow at a certain capillary force, then a lower capillary strength can be used to stop the flow e.g. a larger passageway or a more hydrophilic passageway having weaker capillary forces. The liquid is not able to pass through into an area of weaker capillarity and a stop occurs. The stop can be a combination of the larger area and a lower surface tension force which opposes the entry of the liquid. Alternatively, the liquid can flow from a lower strength capillary into one of much greater strength, i.e. smaller and/or more hydrophilic, prior to entering a larger passageway having a weaker capillary force. This narrow stop increases the stop strength by creating difference in the capillarity into the next area. In either case, liquid is prevented from passing the stop until sufficient force is applied, such as by increasing liquid pressure, to cause the liquid to overcome the surface tension force opposing its movement. It is a feature of the present invention that the force is only needed to start the flow of liquid into the area after the stop. Once the walls of the downstream passageway are in contact with the liquid, the opposing force is overcome since the presence of liquid lowers the energy barrier associated with the downstream capillary. As all capillary forces in the device are strong, the liquid no longer requires force in order to flow once past the stop. While not required, it may be convenient in some instances to continue applying force while liquid flows through the capillary passageways in order to facilitate rapid analysis. Absorbent materials, hydrostatic force, centrifugal force, and air or liquid vacuum and pressure can be used overcome a stop. Flow can resume by capillary forces with or without the assistance of a pressure difference.

The hydrophilicity of capillaries, before a stop, at a stop, and after a stop has an impact on capillary stop strength. Using a stop that is wider and deeper than the capillary, referred to as a “capillary jump” can require accounting for the hydrophilic strength of surfaces before and after the “jump”. Furthermore, this hydrophilic strength of surfaces must be considered relative to the liquid being moved. If the change in dimensions between the capillary at the stop is not sufficient, then the liquid will not stop at the entrance to the wider area. It has been found that the liquid can eventually creep along the walls of the stop. Even with proper design of the shape, control of the degree of hydrophilicity is needed to control liquid movement even further so that stop is effective.

At a stop, a pressure difference must be applied to overcome the effect of the stop. In general, the pressure difference needed is a function of the surface tension of the liquid, the cosine of its contact angle with the capillary and the change in dimensions of the capillary. That is, a liquid having a lower surface tension will require less force to overcome the stop than a liquid having a higher surface tension. A liquid which wets the walls of the hydrophilic capillary, i.e. it has a low contact angle, will require less force to overcome or “jump” the stop than a liquid which has a higher contact angle. The smaller the capillary, the greater the force which must be applied. This force can be generated by any means that allows a greater pressure before the stop than after the stop. In practice, a plunger pushing liquid into a port before the stop or pulling air out of a vent after the stop can provide the force to overcome the stop as effectively as applying a centrifugal force.

In order to design chips in which force is applied to overcome hydrophilic stops empirical tests or computational flow simulation can be used to provide useful information enabling one to arrange the position of liquid-containing wells on chips and size the interconnecting capillary channels so that liquid sample can be moved as required by providing the needed force by adjusting the force applied.

Microfluidic devices can take many forms as needed for the analytical procedures which measure the analyte of interest. The microfluidic devices typically employ a system of capillary passageways connecting wells containing dry or liquid reagents or conditioning materials. Analytical procedures may include preparation of the metered sample by diluting the sample, prereacting the analyte to ready it for subsequent reactions, removing interfering components, mixing reagents, lysising cells, capturing bio molecules, carrying out enzymatic reactions, or incubating for binding events, staining, or deposition. Such preparatory steps may be carried out before or during metering of the sample, or after metering, but before carrying out reactions which provide a measure of the analyte.

### Introducing Liquid Samples

In general, it is desirable that samples are introduced at the inlet port over a very short time, preferably only about one second. The passageways and chambers of a microfluidic chip will ordinarily be filled with air. The small samples, say 0.1 to 2 μL, must completely fill the passageways and chambers to assure that accurate results are obtained from contact of the samples with reagents. If the air is not purged completely from a chamber containing a reagent, only a partial response of the reagent will be obtained. The process begins with the inlet port and extends to the first chamber, which may be the inlet to a reaction chamber, as will be described in an example below.

Since a liquid sample may be introduced in several ways, the actual shape of the opening in the inlet port may vary. The shape of the opening is not considered to be critical to the performance, since several shapes have been found to be satisfactory. For example, it may be merely a circular opening into which the sample is placed. Alternatively, the opening may be tapered to engage a corresponding shape in a pipette which deposits the sample. However, the fit should not be so tight that removing the application causes a negative pressure. In one embodiment, the opening is fitted with a plastic port which is designed to engage a specific type of pipette tip. Such ports could be open or closed so that nothing can enter the microfluidic chip until the port is engaged by the pipette. Depending on the carrier type, the sample may be introduced by a positive pressure, as when a plunger is used to force the sample into the inlet port. However, metering from a pipette is not required. Alternatively, the sample may be merely placed at the opening of the inlet port and capillary action used to pull the sample into the microfluidic chip. Excess sample should not be left on the surface however, since cross-contamination may occur. Also, the sample may be placed at the opening of the inlet port and vacuum used to pull the sample into the microfluidic chip. As has already been discussed, when the opening is small sufficient capillary forces are created by the interaction of the passage walls and the surface tension of the liquid. Typically, biological samples contain water and the walls of the inlet port and associated passageways will be hydrophilic so that the sample will be drawn into the microfluidic chip even in the absence of a positive pressure. However, it should be noted that a negative pressure at the inlet port is not desirable, since it may pull liquid out of the inlet chamber. Means should be provided to prevent a negative pressure from being developed during the introduction of the sample. Creating a positive pressure as by using a plunger to move the sample or providing a vent to atmosphere behind the sample liquid could be used for this purpose.

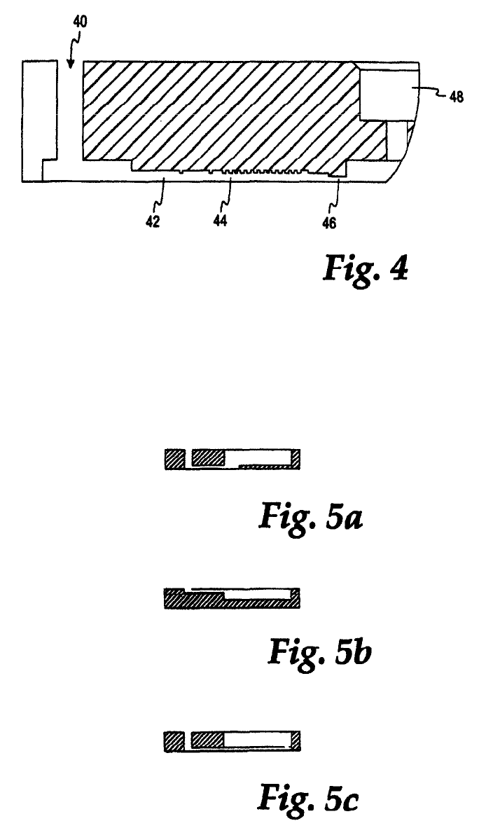

It has been found that the inlet passageway connecting the inlet opening and the first chamber may open into the first chamber through openings located at various positions in the chamber—providing that the liquid is uniformly distributed. FIG. 5 illustrates three possible routes which the inlet passageway may take. In FIG. 5a, the liquid passes through a capillary passageway at the bottom of the chip and enters the inlet chamber in an upwardly direction at the closest point to the inlet port. In FIG. 5b, the capillary passageway extends along the top of the chip and enters the chamber at the closest point. In a third possibility shown in FIG. 5c, the capillary passageway extends along the bottom of the chip, passes under the chamber and enters at the end opposite that used in FIG. 5a. In each case, the chamber has a large volume so it is important to include a means for distributing the liquid across the chamber uniformly. If the liquid is allowed to fill the chamber in a random manner it is possible that air may be trapped in the chamber and not completely purged. In such a case, the air is likely to affect the amount of liquid which is subsequently transferred into metering or reagent chambers. The accuracy of the analytical results obviously will be compromised.

It has been found that removing air uniformly is important to avoid formation of air bubbles which limit access of the liquid samples to reagents or which cause chambers to be less than full. Either result is undesirable. Flow restrictions can be used in the first sample well for example so that the liquid, as it enters from a capillary passageway from the inlet port, is spread uniformly across the sample well, pushing air out through the vent.

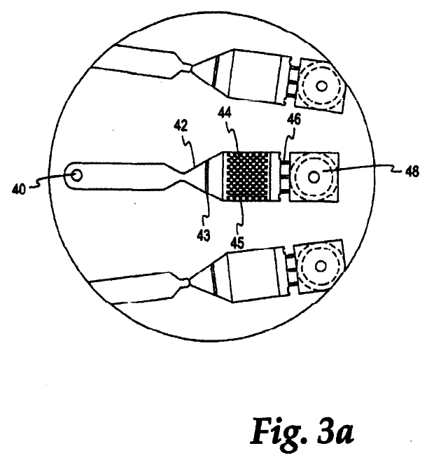

One type of flow restriction that has been found very satisfactory is a groove or a weir which extends across the inlet chamber between the inlet capillary and outlet vents for the air. For example, a groove or weir can been seen (43) in FIG. 3b. The groove or weir may contain wedge-shaped polygon features or curved geometries spaced across the chamber to further assist the uniform distribution of the liquid. Not all grooves or weirs are equally effective, as will be illustrated in Example 5. In general, the width of a groove or weir must be sufficient to prevent by-passing along the walls of the chamber and thus trapping air bubbles.

Alternatively or in addition, microstructures, such as those described below, can provide uniform distribution of a sample liquid over an inlet chamber. When the liquid is distributed by the means described, the pressure required upstream in the inlet capillary is greater, which also affects the movement of the liquid into the downstream passageway. However, as shown in Example 4, below, the capillary forces provided by the microstructures interacting with the liquid should be lower than the capillary forces in the inlet capillary if air is to be completely expelled.

It should also be mentioned that the inlet chamber may not always be empty. It may contain reagents and/or filters. For example, if the inlet chamber contains glass fibers for separating red blood cells from plasma, so that they do not interfere with the analysis of plasma, this step would be carried out before the feature controlling flow of the sample across the chamber is encountered. Blood anti-coagulants may be included in the inlet chamber.

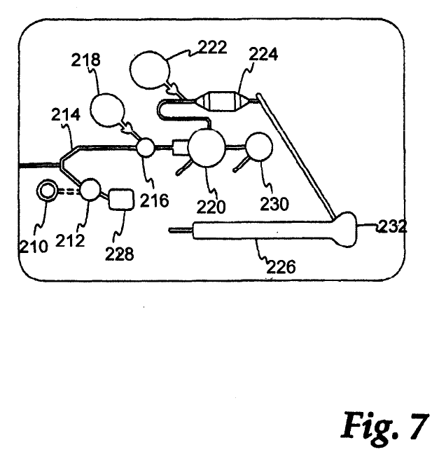

In some microfluidic chips, excess sample is transferred to an overflow chamber or well, in order to be sure that a sufficient amount of the sample liquid has been introduced for the intended analytical procedure. (For example, see wells 228 and 230 in FIG. 7). This is possible when the air vents and any liquid outlet passageways are provided with capillary stops so that the excess liquid is forced to flow into an overflow well. Where the sample is difficult to see easily, because of its color and/or small size, the overflow chamber may contain an indicator. By a change in color for example, when the sample enters the overflow chamber the indicator shows the person carrying out the analysis that the inlet chamber has been filled. One such indicator reagent is the use of a buffer and a pH indicator dye such that when the indicator reagent is wet the pH causes the dye to change color from its dry state. Many such color transition are known to those skilled in the art as well as reductive chemistries and electrochemical signals producing reaction.

### Microstructures

Microstructures are used to assure purging of air from a microfluidic chamber and to uniformly contact liquid sample with a reagent or conditioning agent which has been disposed on a substrate in the chamber. Typically, the reagents will be liquids which have been coated on a porous support and dried. Distributing a liquid sample uniformly and at the same time purging air from the well can be done with various types of microstructures. Thus, they are also useful in the inlet chambers discussed above.

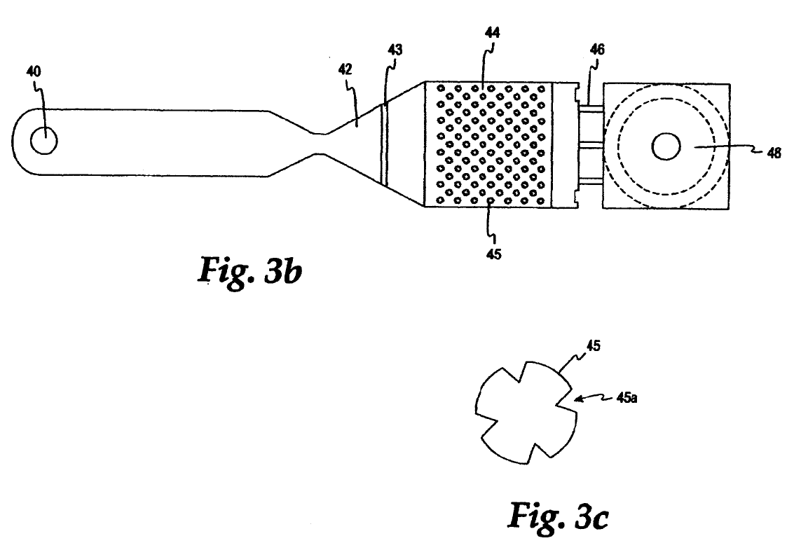

In one preferred microstructure, seen in FIGS. 3a-c and FIG. 4, an array of posts is disposed in reagent area 44, so that the liquid has no opportunity to pass through the inlet chamber in a straight line. The liquid is constantly forced to change direction as it passes through the array of posts 45. Air is purged from the reagent area as the sample liquid surges through the array of posts. It has been found that, contrary to the teachings of Buechler as discussed above, the capillary forces produced by liquid interacting with the posts should be lower than those in the inlet passageway, so that air is completely purged, leaving no air bubbles. This will be discussed more fully in Example 4 below. Each of the posts may contain one or more wedge-shaped cutouts which facilitate the movement of the liquid as discussed in U.S. Pat. No. 6,296,126. The wedge-shaped cutouts 45a have a wedge angle of about 90 degrees or less and a radius of curvature at the wedge-edge smaller than 200 (microns.

Other types of microstructures which are useful include three dimensional post shape with cross sectional shapes that can be circles, stars, triangles, squares, pentagons, octagons, hexagons, heptagons, ellipses, crosses or rectangles or combinations. Microstructures with two dimensional shapes such as a ramp leading up to reagents on plateaus are also useful.

### Applications

Microfluidic devices of the invention have many applications, Analyses may be carried out on samples of many biological fluids, including but not limited to blood, urine, water, saliva, spinal fluid, intestinal fluid, food, and blood plasma. Blood and urine are of particular interest. A sample of the fluid to be tested is deposited in the inlet port and subsequently measured in one or more metering wells into the amount to be analyzed. The metered sample will be assayed for the analyte of interest, including for example a protein, a cell, a small organic molecule, or a metal. Examples of such proteins include albumin, HbAlc, protease, protease inhibitor, CRP, esterase and BNP. Cells which may be analyzed include E. coli, pseudomonas, white blood cells, red blood cells, h. pylori, strep a, Chlamydia and mononucleosis. Metals which are to be detected include iron, manganese, sodium, potassium, lithium, calcium, and magnesium.

In many applications, color developed by the reaction of reagents with a sample is measured. It is also feasible to make electrical measurements of the sample, using electrodes positioned in the small wells in the chip. Examples of such analyses include electrochemical signal transducers based on amperometric, impedimetric, or potentimetric detection methods. Examples include the detection of oxidative and reductive chemistries and the detection of binding events.

There are various reagent methods which could be used in chips of the invention. Reagents undergo changes whereby the intensity of the signal generated is proportional to the concentration of the analyte measured in the clinical specimen. These reagents contain indicator dyes, metals, enzymes, polymers, antibodies, electrochemically reactive ingredients and various other chemicals dried onto carriers. Carriers often used are papers, membranes or polymers with various sample uptake and transport properties. They can be introduced into the reagent wells in the chips of the invention to overcome the problems encountered in analyses using reagent strips.

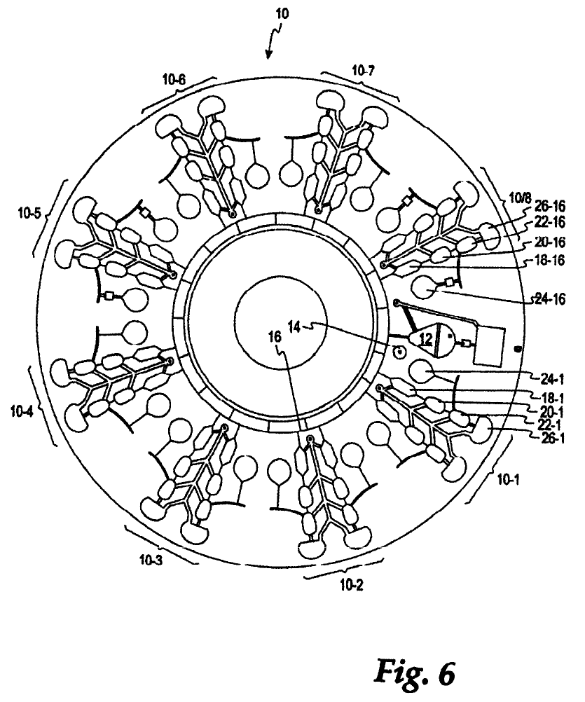

FIG. 6 shows a microfluidic disk 10 for use in analysis of urine for leukocytes, nitrite, urobilinogen, protein, albumin, creatinine, uristatin, calcium, oxalate, myoglobin, pH, blood, specific gravity, ketone, bilirubin and glucose. The disk contains sixteen parallel paths for analysis of urine samples. Each of the parallel paths is equally spaced as pairs in eight radial positions (10-1 to 10-8) and receives a sample distributed from a sample chamber 12 located in a ninth radial position. The sample is introduced through entry port 14. Each parallel path receives a portion of the sample through a capillary ring 16 and is vented through the center of the disk. The parallel paths may be described as follows: a capillary connecting to a metering chamber (18-1 to 18-16), connected via a capillary with a stop to a first reagent well (20-1 to 20-16), connected via another capillary with a stop to a second reagent well (22-1 to 22-16). The second reagent well is connected to a liquid reagent well (24-1 to 24-16) via a capillary with a stop and to a waste chamber (26-1 to 26-16) via a capillary with a stop. All chambers are vented to expel air. The chamber vents for two paths are gathered into a common shared vent and expelled to the bottom of the disk.

Separation steps are possible in which an analyte is reacted with reagent in a first well and then the reacted reagent is directed to a second well for further reaction. In addition a reagent can be re-suspensed in a first well and moved to a second well for a reaction. An analyte or reagent can be trapped in a first or second well and a determination made of free versus bound reagent. A third liquid reagent can be used to wash materials trapped in the second well and to move materials to the waste chamber.

The determination of a free versus bound reagent is particularly useful for multizone immunoassay and nucleic acid assays. There are various types of multizone immunoassays that could be adapted to this device. In the case of adaption of immunochromatography assays, reagents filters are placed into separate wells and do not have to be in physical contact as chromatographic forces are not in play. Immunoassays or DNA assay can be developed for detection of bacteria such as Gram negative species (e.g. E. Coli, Entereobacter, Pseudomonas, Klebsiella) and Gram positive species (e.g. Staphylococcus Aureus, Entereococc). Immunoassays can be developed for complete panels of proteins and peptides such as albumin, hemoglobin, myoglobulin, α-1-microglobulin, immunoglobulins, enzymes, glycoproteins, protease inhibitors, drugs and cytokines. See, for examples: Greenquist in U.S. Pat. No. 4,806,311, Multizone analytical Element Having Labeled Reagent Concentration Zone, Feb. 21, 1989, Liotta in U.S. Pat. No. 4,446,232, Enzyme Immunoassay with Two-Zoned Device Having Bound Antigens, May 1, 1984.

One microfluidic chip that can be used for immunoassays is illustrated in FIG. 7. A sample is deposited in sample inlet 210, from which it passes by capillary action to prechamber 212 containing a weir or groove to assure complete purging of air. Then the liquid enters metering capillary 214. A denaturant/oxidizing liquid is contained in well 218. A mixing chamber 220 provides space and microstructures for mixing the blood sample with the liquid from well 218. Well 222 contains a wash solution which is added to the mixed liquid flowing out of well 220. Chamber 224 contains an array of posts for providing uniform contact of the preconditioned sample with labeled monoclonal antibodies disposed on a dry substrate. Contact of the labeled sample with an agglutinator, which is disposed on a substrate is carried out in chamber 226, producing a color which is measured to determine the amount of glycated hemoglobin in the sample. The remaining wells provide space for excess sample (228), excess denatured sample (230), and for a wicking material (232) used to draw the sample over the substrate in chamber 226.

Potential applications where dried reagents are resolubilized include filtration, sedimentation analysis, cell lysis, cell sorting (mass differences) and centrifugal separation. Enrichment (concentration) of sample analyte on a solid phase (e.g. microbeads) can be used to improve sensitivity. The enriched microbeads could be separated by continuous centrifugation. Multiplexing can be used (e.g. metering of a variety of reagent chambers in parallel and/or in sequence) allowing multiple channels, each producing a defined discrete result. Multiplexing can be done by a capillary array compromising a multiplicity of metering capillary loops, fluidly connected with the entry port, or an array of dosing channels and/or capillary stops connected to each of the metering capillary loops. Combination with secondary forces such as magnetic forces can be used in the chip design. Particles, such as magnetic beads, can be used as a carrier for reagents or for capturing of sample constituents such as analytes or interfering substances. The particles can be separated by physical properties such as density (analog to split fractionation).

### Example 1

In a test chip similar to that of FIG. 5c, the geometry of inlet port opening was varied to demonstrate that the shape of the opening was not critical to filling the inlet chamber. The results of these tests are given in the following table:

| | Depth | Width | Length | | Fluid | |
|---|---|---|---|---|---|---|
| Geometry | mm | mm | mm | Sample | Force | Fill time |
| Rectangle | 0.03 | 0.150 | 1.0 | Whole | Capillary | <1 sec |
| | | | | blood | | |
| Cylinder | 0.100 | 0.100 | 1.0 | Whole | Capillary | <1 sec |
| | | | | blood | | |
| Rectangle | 0.03 | 0.150 | 2.0 | Whole | Capillary | <2 sec |
| | | | | blood | | |
| Rectangle | 0.03 | 0.150 | 2.0 | Urine | Capillary | <1 sec |
| Rectangle | 0.03 | 0.150 | 2.0 | Urine | Positive | <1 sec |
| with | | | | | pressure | |
| adapter | | | | | | |
| Rectangle | 0.03 | 0.150 | 2.0 | Whole | Positive | <1 sec |
| with | | | | blood | pressure | |
| adapter | | | | | | |
| Rectangle | 0.03 | 0.150 | 2.0 | Whole | Negative | <2 sec |
| with | | | | blood | pressure | |
| adapter | | | | | | |

Using a capillary as the inlet port, the inlet chamber was filled in the less than 2 seconds with and without an adapter at the inlet. The fill time was dependent on the fluid used as well as the surface energy of the capillary and the length, width or shape of the capillary.

### Example 2

Using a test chip similar to that of Example 1, the pressure and volumes used to add fluid to the inlet chamber via the port opening were varied. The inlet chamber volume was 5 μL and a metering loop having a volume of 0.3 μL received liquid when the inlet chamber was filled. The experiment was performed with blood and urine.

| Volume | | | |
|---|---|---|---|
| (μL) | Sample delivery device | Pressure | Observation |
| 5 | Capillary without plunger | Target | Metering occurs |
| 4 | Capillary without plunger | Target | Metering occurs |
| 6 | Capillary without plunger | Target | Metering occurs & |
| | | | excess overflows |
| 5 | Capillary with plunger | High | Metering occurs |
| 4 | Capillary with plunger | High | Metering occurs |
| 6 | Capillary with plunger | High | Metering occurs & |
| | | | excess overflows |
| 5 | Capillary with plunger | Low | Metering occurs |
| 4 | Capillary with plunger | Low | Metering occurs |
| 6 | Capillary with plunger | Low | Metering occurs & |
| | | | excess overflows |

Pressure applied either by capillary action or by use of a plunger allowed acceptable filling over a wide range of sample volumes 4-6 μL. In the case of an over fill, the excess fluid exits through the inlet chamber vent and the metering loop. An overflow chamber is therefore desirable to receive excess sample. This chamber would fill when the metering loop is completely filled and excess sample overflows. Capillary stops should be used to assure complete filling of the inlet chamber and that the overflow chamber receives the excess sample liquid.

### Example 3

The microfluidic device of FIGS. 3a-c and 4 was used to measure the glucose content of blood. Whole blood pretreated with heparin was incubated at 250° C. to degrade glucose naturally occurring in the blood sample. The blood was spiked with 0, 50, 100, 200, 400, and 600 mg/μL of glucose as assayed on the YSI glucose instrument (YSI Instruments Inc.). A glucose reagent (chromagenic glucose) reagent as described in Bell U.S. Pat. No. 5,360,595 was coated on a nylon membrane disposed on a plastic substrate. A sample of the reagent was placed in chamber 44 and the bottom of the device covered with Excel Sealplate (Excel Scientific Inc.).

Samples of blood containing one of the concentrations of glucose were introduced into inlet port 40 using a 2 μL capillary with plunger (Drummond Aqua). Since the inlet port is sealed when the sample is dispensed, a positive pressure is established which forces the sample into the inlet passageway 42 and then into the reagent area 44. The sample reacted with the reagent to provide a color change, which is then read on a spectrometer at 680 nm, as corrected against a black and white standard. Air is expelled through passages 46 and exits through vent 48.

Two plastic substrates, PES and PET, were used with the series of blood samples. Where PET coated with reagent was used, a 500 nm to 950 nm transmittance meter was used to read the reaction with the sample. Where PES coated with reagent was used a bottom read reflectance meter was used to read the reaction with the sample.

The results are compared with a conventional procedure, YSI results. Comparable results were obtained, as can be seen in the following table.

TABLE 2

| Expected | Observed |
|---|---|
| Glucose | Glucose (n = 6) |
| 0 | 0.3 |
| 50 | 48.5 |
| 100 | 103.1 |
| 200 | 197.3 |
| 400 | 409.1 |
| 600 | 586.7 |

### Effect of Capillary Forces in Air Removal

When liquid enters an inlet chamber, the capillary forces generally are reduced since the cross-sectional area of the chamber is larger than that of the capillary passageway through which it enters. But, as shown in the Buechler patents discussed earlier, if an array of posts is added to the inlet chamber, the capillary forces can be increased. Buechler teaches that the array of posts should be spaced so that the capillary forces are equal to or greater than the capillary force that moved the liquid through the entry capillary. Furthermore, Buechler teaches that the capillary forces in the inlet chamber should be induced by the lateral walls of the chamber, that is, the posts should be closely spaced. In the entry capillary, the capillary forces were induced by the top and base surfaces. In other words, the capillary forces are induced by the vertical surfaces of the entry capillary, but are induced by the horizontal surfaces of the posts in the chamber. In the present invention, the capillary forces are lower in the inlet chamber than in the entry capillary in order to assure that the air initially present is completely expelled. As will be shown below, the spacing of posts, if used, should be equal to or greater than the height of the inlet chamber. That is, the opposite of the designs taught by Buechler.

A mathematical model which relates the height as an inlet chamber to capillary force is

K_{c}≈(λ_{L}−λ_{S})/h

Where:
K_{c} is the induced capillary force
h is the height of the chamber.
λ_{L} is the surface energy of the liquid.
λ_{S} is the surface energy of the chamber surface.
   The equation shows the relation between the variables such that increasing chamber height lowers the induced capillary force, decreasing chamber height increases the induced capillary force, and that increasing the difference on surface energy between the liquid and the chamber surface increases the induced capillary force.

When an array of posts is added to the chamber, a similar model can be applied which introduces the effect of the lateral surfaces of the posts.

K_{c}≈(λ_{L}−λ_{S})/(h+ [symbol] )

K_{c}, λ_{L}, λ_{S} and h have the same meaning as the first equation. [symbol] is the % of the chamber area covered by the posts. [symbol] is the spacing of the posts minus the chamber height. In general, it will be evident that if the post spacing is less than the chamber height, a negative number results and the capillary force induced by the chamber height is lower than the capillary force induced by the spacing the posts. Thus, the induced capillary force can be controlled by the height of the chamber or by the post spacing.

### Example 4

The effect of changing the spacing of the posts is shown in the following table, which reports the results of experiments in which the post spacing was varied. The chamber used was 5 mm wide, 7 mm long, with a height of 150 μm. The contact angle of the liquid was 90° (on a neutral surface) and on the chamber surface 33°.

| | Posts | | | | | |
|---|---|---|---|---|---|---|
| | | Spacing | | Chamber | | Air left in |
| Test No. | Type | (μm) | [symbol] | Height (μm) | [symbol] | chamber |
| 1 | none | 0 | 0 | 150 | 0 | 22% |
| 2 | 50 μm | 50 | 50% | 150 | −100 | 44% |
| 3 | 50 μm | 100 | 50% | 150 | −50 | 17% |
| 4 | 50 μm | 200 | 25% | 150 | +50 | 2% |

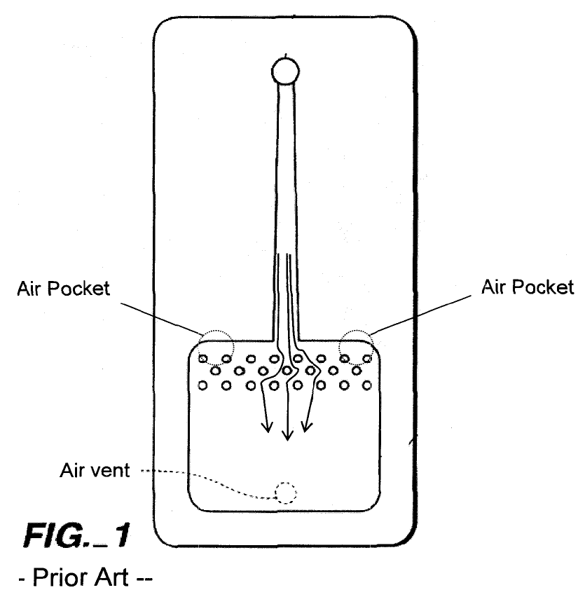

When liquid enters the chamber and moves too quickly, it tends to reach the vent, which is usually opposite the entry, and trap air as a bubble, as in Buechler (FIG. 1). The trapped air is measured by the size of the bubble in the table. It can be seen that when no posts are present (test 1) air is trapped in the chamber, which is to be avoided if an assay is to give reliable results. When the posts have a narrow spacing (test 2) relative to the height of the chamber, the size of the air bubble is larger than in an empty chamber (test 1). The capillary force is induced by the lateral walls of the posts. In test 3, when the spacing of the posts again is smaller than the chamber height and consequently the capillary forces remain induced by the lateral walls of the posts, less air is trapped in the chamber. In test 4, the post spacing is larger than the height of the chamber and therefore the capillary forces are induced by the inner vertical surfaces. Substantially all of the air has been expelled. The purging of air should be at least as comprehensive as necessary to prevent the air from interfering with the test result. For a point-of-care assay, the air should be purged so that the air left in the chamber should be no more than 10%. In a preferred embodiment, the air should be purged so that the air left in the chamber should be no more than 5% and, more preferably, no more than 2%.

Additional tests were done in which distribution of liquid employed a groove across the inlet chamber in the absence of an array of posts. As will be seen in the following table, the width of the groove also affects the amount of air trapped in the empty chamber. A wide groove is more effective than a narrow one in expelling air from the chamber.

| Groove | | | | |
|---|---|---|---|---|
| width (μm) | [symbol] | Chamber Height (μm) | [symbol] | Air left in chamber |
| 250 | 5% | 150 | +100 | 5% |
| 50 | 1% | 150 | −100 | 33% |

Chambers typically have widths of about 4 to 10 mm, preferably about 5-6 mm, depths of about 200 to 5000 μm, and lengths of about 200 to 500 μm. The volume will be determined by the liquid which is to be held, e.g. a sample, a reagent, or conditioning liquid. The microstructure chosen may be an array of posts, grooves or weirs perpendicular to the direction of liquid.

In view of the above, a number of principles were formulated to reduce the amount of air trapped in microfluidic chambers. FIG. 2 is referenced again to illustrate these general principles. First, the capillary forces within the chamber 130 should be less than the capillary forces within the capillary channel 120. Second, at least one microstructure 140 should be used to spread the fluid across the chamber 130. The microstructure 140 may be one or more individual posts, an array of posts, a groove or weir etc. Preferably, at least one array of microposts or at least one groove or weir should be used. More preferably, the microstructure or microstructures should cover a chamber area ( [symbol] ₙ) of 50% or less, with 5% to 25% being a more preferable range. Various microstructures may be used in combination. It is understood that placement of the microstructures within the chamber may vary. For example, FIG. 2 illustrates the microstructure placement at the entrance of the chamber 130 near the inlet capillary channel 120. It is understood that the microstructures 140 could have been arranged so that their placement extended from one end of the chamber 130 to the vent 132 across the entire chamber 130. Third, the width or spacing between the microstructures 140 should be greater than the height of the chamber 130. In other words, [symbol] in the equation above should be a positive number. In the case of a groove or weir, the width of said groove or weir should be greater than the height of the chamber. In a preferred embodiment, the width of or spacing between the microstructures should be 10% to 100% greater than the height of the chamber. In a more preferred embodiment, the width or spacing between the microstructures should be 25% to 75% greater than the height of the chamber.

### Using Overflow Chambers

As described above, an inlet chamber should be filled completely and all the air ejected so that the desired amount of liquid is present in the chamber. However, if more than the desired amount of liquid is introduced, the excess must be removed. A passageway could be provided between the inlet chamber an overflow chamber. However, since an inlet chamber typically is connected to other chambers that make up the microfluidic circuit, the excess liquid also can flow into the other chambers or passageways, rather than to the overflow chamber. Because it is desirable to measure out a fixed amount of liquid and then transfer it to the downstream fluidic circuit, the overflow well should catch all of the excess liquid. It has been found that if a capillary stop is provided in the outlet passageways from the inlet chamber, including at the air vent, that the excess liquid flows only to the overflow chamber, where a means for detecting presence of the liquid can be provided.

### Example 5

In the following example an inlet chamber 5 mm wide, 7 mm long, and 150 μm high has an overflow passageway 1 mm wide, 0.5 mm deep, and 5 mm long extending to an overflow chamber 5 mm wide, 1 mm deep and 5 mm long. Two additional outlet passageways were tested for their ability to cause liquid to flow into the overflow chamber through the overflow passageway. The larger outlet passageway was 1 mm wide, 0.5 mm deep, and 5 mm long. The smaller outlet passageway also was 5 mm long but only 0.15 mm wide and 0.15 mm deep. Liquids tested were either specimens or specimens diluted with liquid reagents. The liquids were introduced to the inlet chamber applying a droplet on the chip surface at the inlet port and filling the inlet chamber by capillary force. After filling the chamber the excess liquid either flowed to the overflow chamber (desired) or into the outlet passageway (not desired). The presence of liquid in the overflow chamber can be detected by a indicator as discussed above. The following table shows the results:

| Volume | | | Flow to | Flow |
|---|---|---|---|---|
| of Inlet | Volume Added | Outlet | Overflow | into Outlet |
| Chamber | (μL) | passageway type | Chamber | Passageway |
| 3 | 6 | Large | No | Yes |
| 3 | 6 | Small | Yes | No |

If no overflow chamber is included, then excess liquid flows into the outlet passageway regardless of its size, which is undesirable since the added liquid volume is no longer that volume measured by filling the inlet chamber. Consequently, an assay which depends on an accurate liquid measure is no longer as precise as desired. The results will vary, depending on the amount of liquid added, which may not be as closely controlled as one would like.

In this example the contact angle of the surface was 33°, while the contact angle of the liquids (on a neutral surface) was, being close to water, 90°, so that hydrophilic capillary force moved the liquid. Under these conditions, the smaller outlet passageway provided a capillary stop at the entrance to a downstream chamber, hereby causing the excess liquid to flow to the overflow chamber. Where the outlet passageway was larger, there was an insufficiently strong capillary stop to resist further liquid flow into the downstream fluidic circuit and the overflow chamber was not effective. Thus, all the exits from the inlet chamber should be provided with capillary stops, including the air vent to assure that excess liquid is directed to the overflow chamber.

1. A method of supplying liquid to a microfluidic device having an inlet port in fluid communication with an inlet chamber via a capillary passageway, said method comprising;
(a) introducing a portion of said liquid into said inlet port;
(b) transferring by capillary forces said liquid portion of (a) to said inlet chamber via said capillary passageway;
(c) distributing said liquid portion of (a) uniformly across said inlet chamber and purging substantially all air from said inlet chamber with microstructures disposed in said inlet chamber, said microstructures disposed to reduce the capillary forces moving said liquid portion relative to the capillary forces in said capillary passageway.

2. A method of claim 1 wherein said microstructures are an array of posts having a spacing between said posts equal to or greater than the height of said inlet chamber, whereby the capillary forces moving said liquid portion of (a) produced by the base and top of said inlet chamber are greater than the capillary forces produced by the spacing between said posts.

3. A method of claim 1 wherein said microfluidic structures are one or more grooves or weirs disposed at a right angle to the flow of said liquid portion, said groove(s) or weir(s) having width greater than the height of said inlet chamber, whereby the liquid portion of (a) is moved by capillary forces produced by the base and top of said inlet chamber and said groove(s) spread said liquid portion uniformly across said inlet chamber.

4. A method of claim 3 wherein said groove(s) or weir(s) contain wedge-shaped cutouts to facilitate uniform flow of said liquid portion of (a).

5. A method of claim 2 wherein said posts contain wedge-shaped cutouts to facilitate uniform flow of said liquid portion of (a).

6. A method of claim 1 wherein said inlet port is tapered to engage the corresponding shape of a pipette for depositing said liquid portion of (a).

7. A method of claim 1 wherein excess of said liquid portion of (a) is diverted to an overflow chamber after said inlet chamber is filled.

8. A method of claim 7 wherein the presence of said excess of the liquid portion of (a) is detected by an indicator in said overflow chamber.

9. A method of claim 2 wherein the height of said inlet chamber is smaller than the spacing between said posts.

10. A method of claim 1 wherein positive pressure is applied to said liquid portion of (a) to assist said transfer by capillary forces.

11. A method of claim 1 wherein air is purged from a vent that includes a capillary stop to prevent liquid from exiting through said vent.

12. A method of claim 7 wherein capillary stops are provided to force excess liquid into said overflow chamber.

13. A microfluidic device for assaying a liquid biological sample comprising
(a) an inlet port for receiving said sample;
(b) a capillary passageway in fluid communication with said inlet port for moving said sample by capillary forces;
(c) an inlet chamber in fluid communication with the capillary passageway of (b), said inlet chamber containing microstructures disposed to reduce capillary force moving said sample relative to the capillary forces in said capillary passageway of (b), thereby distributing said sample across said inlet chamber and displacing air from said inlet chamber, and
(d) at least one vent passageway for removing air displaced by said liquid sample.

14. A microfluidic device of claim 13 wherein said microstructures are an array of posts having a spacing between said posts equal to or greater than the height of said inlet chamber, whereby the capillary forces moving said sample produced by the base and top of said inlet chamber are greater than the capillary forces produced by the spacing between said array of posts.

15. A microfluidic device of claim 13 wherein said microfluidic structures are one or more grooves or weirs disposed at a right angle to the flow of said sample, said grooves or weirs having a width greater than the height of said inlet chamber, whereby said sample is moved by capillary forces produced by the base and top of said inlet chamber and said groove(s) spread said sample uniformly across said inlet chamber.

16. A microfluidic device of claim 15 wherein said groove(s) or weir(s) contain wedge-shaped cutouts to facilitate uniform flow of said sample.

17. A microfluidic device of claim 14 wherein said posts contain wedge-shaped cutouts to facilitate uniform flow of said sample.

18. A microfluidic device of claim 13 wherein said inlet port is tapered to engage the corresponding shape of a pipette for depositing said sample.

19. A microfluidic device of claim 13 further comprising an overflow chamber in fluid communication with said inlet chamber to receive liquid in excess of said sample.

20. A microfluidic device of claim 19 wherein said overflow chamber contains an indicator to detect presence of said sample.

21. A microfluidic device of claim 14 wherein the height of said inlet chamber is smaller than the spacing between said posts.

22. A microfluidic device of claim 13 wherein said vent passageway includes a capillary stop to prevent liquid from exiting through said vent.

23. A microfluidic device of claim 19 wherein capillary stops are disposed to force liquid into said overflow chamber.
